(19) United States
(12) Patent Application Publication
(10) Pub. No.: US 2025/0261281 A1
(43) Pub. Date: Aug. 14, 2025

(54) DEVICE ASSIST FOR 5G STAND-ALONE (SA) FEMTO-CELL MANAGEMENT

(71) Applicant: Apple Inc., Cupertino, CA (US)

(72) Inventors: Sundarraman BALASUBRAMANIAN, Paris (FR); Nordine KADRI, Groslay Val-d'Oise (FR); Vijay VENKATARAMAN, San Jose, CA (US)

(21) Appl. No.: 18/952,760

(22) Filed: Nov. 19, 2024

Related U.S. Application Data
(60) Provisional application No. 63/552,593, filed on Feb. 12, 2024.

(51) Int. Cl. H04W 76/38; H04W 28/20; H04W 48/08

(52) U.S. Cl. CPC H04W 76/38; H04W 28/20; H04W 48/08

(57) ABSTRACT

Embodiments described herein relate to methods and apparatus for managing connection to a fifth generation (5G) stand-alone (SA) femto-cell of a wireless network to control bandwidth used by a wireless device. When the wireless device is camped on a 5G SA femto-cell in an idle state, via a wider bandwidth channel of a higher radio frequency (RF) band, for a period of time without a bandwidth part (BWP) being configured, the wireless device can determine to release connection to the 5G SA femto-cell and re-associate with the wireless network via a narrower bandwidth channel of a lower RF band when certain conditions are satisfied, such as i) when the wireless device is stationary and i) a non-cellular wireless connection is available for data transfer and/or 5G new radio (NR) carrier aggregation (CA) is available to the wireless device.

### CROSS-REFERENCE TO RELATED APPLICATIONS

The present application claims the benefit of U.S. Provisional Application No. 63/552,593, entitled “DEVICE ASSIST FOR 5G STAND-ALONE (SA) FEMTO-CELL MANAGEMENT,” filed Feb. 12, 2024, the content of which is incorporated by reference herein in its entirety for all purposes.

### FIELD

The described embodiments relate to wireless communications, including methods and apparatus for managing connections to fifth generation (5G) stand-alone (SA) femto-cells to control bandwidth used by a wireless device.

### BACKGROUND

Newer generation, such as fifth generation (5G), cellular wireless networks that implement one or more 3rd Generation Partnership Project (3GPP) 5G standards are being developed and deployed by network operators worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Network operator deployment of 5G standalone (SA) wireless networks will require years of infrastructure improvement. Present fourth generation (4G) long term evolution (LTE) wireless networks will continue to be available, and 5G non-standalone (NSA) wireless networks that provide radio connections via both 4G LTE and 5G new radio (NR) technology in parallel allow for a gradual transition to 5G SA wireless networks. Mobile network operators (MNOs) are deploying 5G SA femto-cells to add availability of 5G SA in access networks in select locations. Some 5G SA femto-cells are configured without a bandwidth part (BWP) feature, thereby requiring wireless devices to monitor entire bandwidths of channels at radio frequencies that cause increased power consumption by the wireless device. There exists a need for mechanisms to enable a wireless device to manage connections to a wireless network to provide for more efficient power consumption when the BWP feature is not available for a 5G SA femto-cell.

### SUMMARY

This application relates to wireless communications, including methods and apparatus for managing connections to fifth generation (5G) stand-alone (SA) femto-cells to control bandwidth used by a wireless device. While camped on a 5G SA femto-cell of a wireless network in an idle mode via a wider bandwidth channel in a higher radio frequency (RF) band, a wireless device can monitor for use of a bandwidth part (BWP) feature deployed by the 5G SA femto-cell. When the BWP feature is not configured, the wireless device can be required to monitor the entire bandwidth of the wider bandwidth channel in the higher RF band. When the 5G SA femto-cell configures the BWP feature for the wireless device to use less than the entire bandwidth of the wider bandwidth channel, the wireless device can remain camped on the 5G SA femto-cell using a smaller portion of the wider bandwidth channel in the higher RF band. The wireless device can also determine availability of 5G SA carrier aggregation (CA) based on a measurement configuration provided by the 5G SA femto-cell. When the wireless device is stationary for a period of time without the BWP feature being configured for the wireless device by the 5G SA femto-cell, the wireless device can determine whether to remain camped on the 5G SA femto-cell via the wider bandwidth channel in the higher RF band based on availability of 5G SA CA and on availability of a non-cellular wireless connection to support active data transfer. When 5G SA CA is available or when a non-cellular wireless connection is available, the wireless device can disassociate from the 5G SA femto-cell, e.g., by dropping a radio resource control (RRC) connection to the 5G SA femto-cell. Subsequently, the wireless device can camp on the wireless network via a narrower bandwidth channel in a lower RF band, e.g., re-associate with the 5G SA femto-cell or with another cell of the wireless network. The wireless device can conserve power by using a narrower bandwidth channel in a lower RF band rather than using a wider bandwidth channel in a higher RF band of the wireless network. The wireless device can cause the shift from the higher RF band to the lower RF band, as the wireless network may not initiate the required change. In some embodiments, the narrower bandwidth channel spans a bandwidth of no more than one-half or on-quarter of the bandwidth of the wider bandwidth channel. In some embodiments, the narrower bandwidth channel spans no more than 20 MHz, while the wider bandwidth channel spans at least 100 MHz. In some embodiments, the lower RF band spans frequencies below 2 GHz. In some embodiments, the higher RF band spans frequencies from 2 GHz to 6 GHz or above 24 GHz. The wireless device can refrain from providing measurements for one or more channels of the higher RF band to the wireless network to keep the wireless network from switching the wireless device back to the higher RF band from the lower RF band. The wireless device can monitor performance of the channel while in the lower RF band and resume providing measurements for the higher RF band to the wireless network when performance in the lower RF band does not satisfy a performance threshold, e.g., decreases by more than a configurable performance threshold amount.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement cellular service provisioning to a wireless device, according to some embodiments.

FIG. 2 illustrates a block diagram of a more detailed view of exemplary components of the system of FIG. 1, according to some embodiments.

FIGS. 3A and 3B illustrate block diagrams of 5G non-standalone and standalone network architectures, according to some embodiments.

FIGS. 4A and 4B illustrate examples of different types of cell coverage for cellular wireless networks that deploy multiple radio access technologies (RATs), according to some embodiments.

FIG. 4C illustrates typical maximum channel bandwidths for different 5G NR frequency bands, according to some embodiments.

FIG. 5 illustrates a diagram of an exemplary mechanism to manage connections to a 5G SA femto-cell by a wireless device, according to some embodiments.

FIG. 6 illustrates an exemplary method performed by a wireless device implementing a 5G SA femto-cell channel management procedure, according to some embodiments.

FIG. 7 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus for managing connections to fifth generation (5G) stand-alone (SA) femto-cells to control bandwidth used by a wireless device. Mobile network operators (MNOs) are deploying 5G SA femto-cells to add availability of 5G SA in access portions of wireless networks in select locations, e.g., across enterprise campuses, in sports arenas, in public transportation centers, and the like. A 5G SA cell of a wireless network can implement a bandwidth part (BWP) feature to allocate a subset of available bandwidth of a channel to a wireless device. Advantageously, the BWP feature allows efficient sharing of the channel bandwidth across multiple wireless devices, with each wireless device required to monitor only the bandwidth part allocated to the wireless device, which conserves power for the wireless device. Some 5G SA femto-cells are deployed and configured without a bandwidth part (BWP) feature, thereby requiring wireless devices to monitor entire bandwidths of a channel of the 5G SA femto-cell with which the wireless device is associated, which increases power consumption by the wireless device. To reduce power consumption, the wireless device can implement a mechanism to determine whether to remain camped on a 5G SA femto-cell in a wider bandwidth channel in a higher radio frequency (RF) band or to move to a narrower bandwidth channel in a lower RF band.

While camped on a 5G SA femto-cell of a wireless network in an idle mode via a wider bandwidth channel in a higher RF band, the wireless device can monitor for use of a bandwidth part (BWP) feature of 5G by the 5G SA femto-cell. When the 5G SA femto-cell configures the BWP feature for the wireless device to use less than the entire bandwidth of the wider bandwidth channel, the wireless device can remain camped on the 5G SA femto-cell using a smaller portion of the wider bandwidth channel in the higher RF band. When the 5G SA femto-cell does not configure the BWP feature, the wireless device can initiate a switch to a narrower bandwidth channel in a lower RF band when certain conditions are met. The wireless device can determine availability of 5G SA carrier aggregation (CA) based on a measurement configuration for the 5G SA femto-cell. The availability of 5G SA CA by the 5G SA femto-cell for the wireless device can influence a decision by the wireless device to remain on the wider bandwidth channel of the higher RF band or to switch to a narrower bandwidth channel of a lower RF band. In some cases, e.g., when the wireless device is located in an area with poor penetration (coverage) of signals that use higher RF bands, additional lower RF bands and/or medium range RF bands are likely to be deployed by wireless networks to enhance coverage for wireless devices. In such cases, if there is no availability of 5G SA CA, the wireless devices can be limited to lower data throughput rates in a downlink direction and/or in an uplink direction due to the marginal coverage conditions for the higher RF bands at the location where the wireless device is operating. To avoid such conditions impacting performance, a wireless device can monitor for 5G SA CA deployments by the wireless network. The wireless device can also determine a mobility state of the wireless device, e.g., whether the wireless device is stationary or changing position where the wireless device may be likely to reselect (or handover) to a different cell. The wireless device can determine stationarity based on whether it remains connected to the same 5G SA femto-cell for a pre-determined period of time. Femto-cells have a limited coverage area, and the wireless device can be substantially stationary when camped on a particular femto-cell continuously for a period of time. When the wireless device is stationary without the BWP feature being configured for the wireless device by the 5G SA femto-cell, the wireless device can further determine whether to remain camped on the 5G SA femto-cell via the wider bandwidth channel in the higher RF band based on i) availability of 5G SA CA and on ii) availability of a non-cellular wireless connection to support active data transfer.

When 5G SA CA is available via the 5G SA femto-cell or when a non-cellular wireless connection is available that can support active data transfer, the wireless device can disassociate from the 5G SA femto-cell, e.g., by dropping a radio resource control (RRC) connection to the 5G SA femto-cell. Subsequently, the wireless device can camp on the wireless network via a narrower bandwidth channel in a lower RF band, e.g., re-associate with the 5G SA femto-cell in the lower RF band or associated with another cell of the wireless network, e.g., a macro-cell of the wireless network or a cell that uses a different radio access technology (RAT), such as a fourth generation (4G) long term evolution (LTE) cell, which can be deployed with lower bandwidth channels. The wireless device can conserve power by using the narrower bandwidth channel in the lower RF band (via the same 5G SA femto-cell or via a different cell of the wireless network) rather than using the wider bandwidth channel in the higher RF band of the wireless network. The wireless device can cause the shift from the higher RF band to the lower RF band, as the wireless network may not initiate the required change. In some embodiments, the narrower bandwidth channel spans a bandwidth of no more than one-half or on-quarter of the bandwidth of the wider bandwidth channel. In some embodiments, the narrower bandwidth channel spans no more than 20 MHZ, while the wider bandwidth channel spans at least 100 MHz. In some embodiments, the lower RF band spans frequencies below 2 GHZ, and the higher RF band spans frequencies from 2 GHz to 6 GHz or above 24 GHz. A typical maximum bandwidth for a channel in a lower RF band spans 20 MHz, while a typical maximum bandwidth in a higher RF band spans 100 MHz for frequencies in the 2 GHz to 6 GHz range or spans 400 MHZ for frequencies above 24 GHz. Enabling the wireless device to only monitor 20 MHz (or less) rather than 100 MHZ (or more) can substantially conserve limited battery power in the wireless device. By switching while in the idle state (rather than in the connected state), the wireless device can avoid interrupting active data transfer while conserving battery power.

After switching to the lower RF band, the wireless device can refrain from providing measurements for one or more channels of the higher RF band to the wireless network to keep the wireless network from switching the wireless device back to the higher RF band from the lower RF band. The wireless device can monitor performance of the channel while in the lower RF band and resume providing measurements for the higher RF band to the wireless network when performance in the lower RF band does not satisfy a performance threshold, e.g., decreases by more than a configurable performance threshold amount. In some embodiments, when the wireless network, following a fallback procedure, moves the wireless device to the higher RF band on the 5G SA femto-cell that did not configure BWP for the wireless device, the wireless device can release connection to the higher RF band substantially immediately and camp on a channel in the lower RF band.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

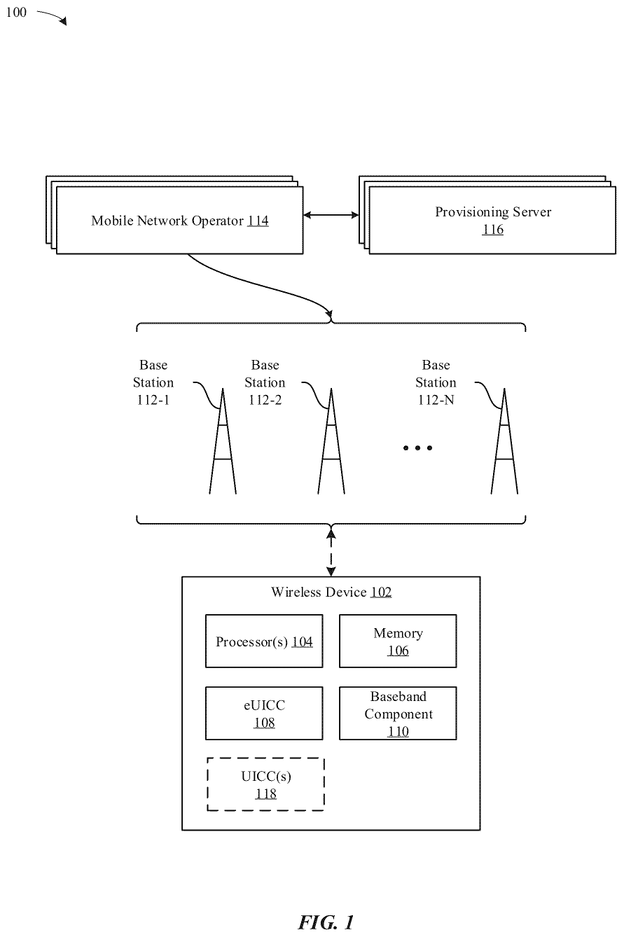

These and other embodiments are discussed below with reference to FIGS. 1 through 7; however, those skilled in the art will readily appreciate that the detailed description given herein with respect to these figures is for explanatory purposes only and should not be construed as limiting.

FIG FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

In some embodiments, a wireless device configuration can determine whether the wireless device can access services via one or more particular radio access technologies (RATs), e.g., via a 5G standalone (SA) connection to a 5G SA cellular wireless network, via a 5G non-standalone (NSA) connection to a 5G NSA cellular wireless network, or via a 4G LTE connection to a 4G LTE cellular wireless network. In some embodiments, the wireless device can determine to switch from using a wider bandwidth channel in a higher radio frequency (RF) band, e.g., while camped on a 5G stand-alone (SA) femto-cell of a wireless network, to a lower bandwidth channel in a lower RF band, e.g., on the 5G SA femto-cell or on another cell of the wireless network.

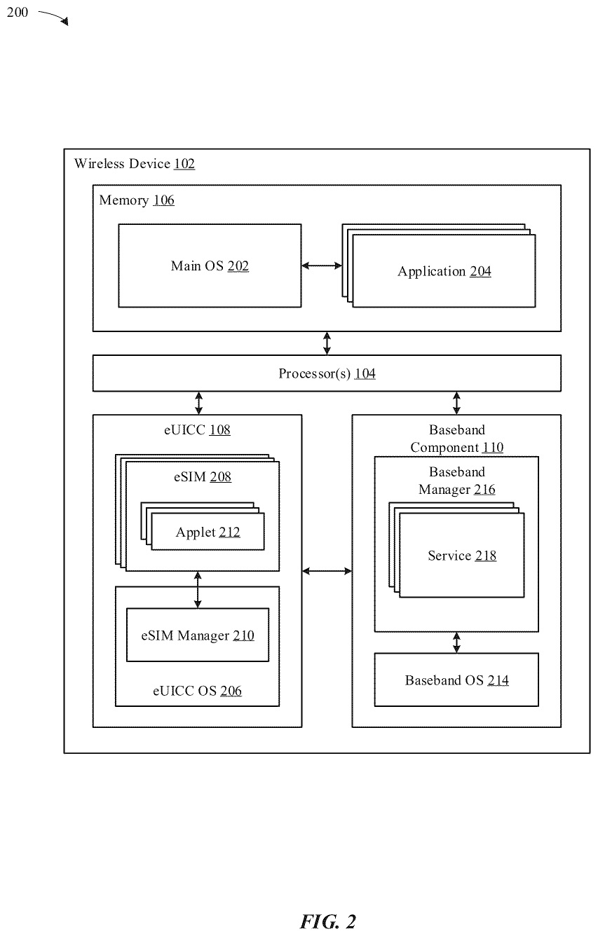

FIG. 2 illustrates a block diagram 200 of a more detailed view of exemplary components of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states. The communications control circuitry, in some embodiments, can also determine whether the wireless device 102 can access particular RATs, such as access to 5G SA cellular connections. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

A baseband component 110 of the wireless device 102 can include a baseband OS 214 that is configured to manage hardware resources of the baseband component 110 (e.g., a processor, a memory, different radio components, etc.). According to some embodiments, the baseband component 110 can implement a baseband manager 216 that is configured to interface with the eUICC 108 to establish a secure channel with a provisioning server 116 and obtaining information (such as eSIM data) from the provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

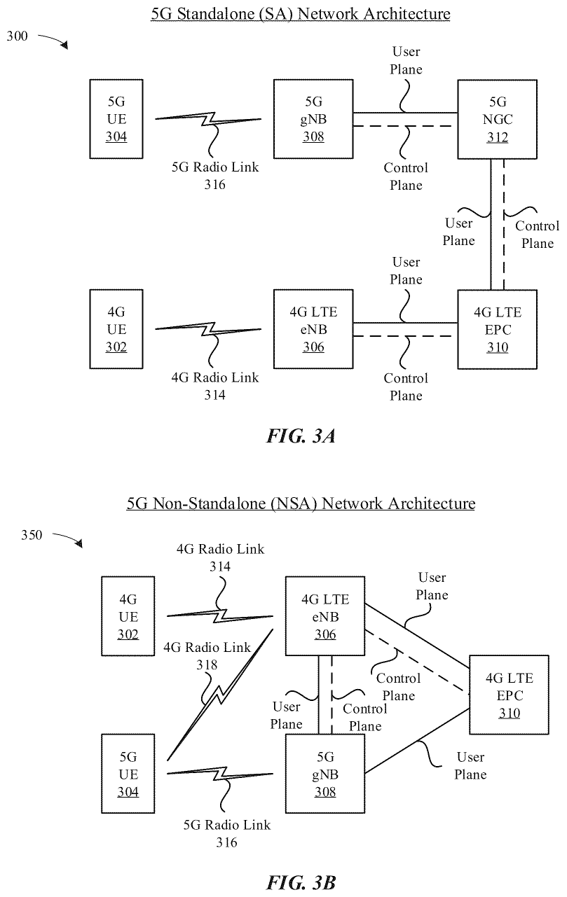

FIGS. 3A and 3B illustrate block diagrams 300/350 of 5G standalone (SA) and non-standalone (NSA) network architectures respectively. Operating in a SA mode, as shown in FIG. 3A, a 5G user equipment (UE) 304 communicates with a cellular wireless network via a 5G radio link 316 to a 5G gNB (base station) 308, while a 4G UE 302 separately communicates with its own cellular wireless network via a 4G radio link 314 to a 4G LTE eNB 306. The 5G gNB 308 is connected to a 5G next generation core (NGC) network 312 including both a user plane connection for data transfer and a control plane connection for control signaling. Similarly, the 4G LTE eNB 306 is connected to a 4G LTE enhanced packet core (EPC) 310. The 4G LTE EPC 310 network can interwork with the 5G NGC 312 network via user plane and control connections between them. 5G SA networks that include both 5G access networks based on 5G gNBs 308 and a 5G NGC 312, however, are expected to take multiple years to build out, and as such a hybrid network that includes elements of both a 4G cellular wireless network and a 5G cellular wireless network is planned for 5G UEs 304 to operate in an NSA mode as illustrated by FIG. 3B. Operating in a NSA mode, a 5G UE 304 communicates with a cellular wireless network via both a 5G radio link 316 to a 5G gNB 308 and via a separate 4G radio link 318 to a 4G LTE eNB 306. The 4G LTE eNB 306 can be used for control plane signaling and act as a primary node for access network connection with the 5G UE 304, while the 5G gNB 308 can be used for user plane data transfer and act as a secondary node for access network connection with the 5G UE 304. The 5G gNB 308 can transfer user plane data to the 4G LTE EPC 310 when directly connected to the 4G LTE EPC 310 or when indirectly connected to the 4G LTE EPC 310 via the 4G LTE 3NB 306, as indicated by the user plane connection between the 4G LTE eNB 306 and the 5G gNB 308. A 4G UE 302 (or a 5G UE 304 operating in a 4G LTE mode) can connect to the 4G LTE eNB 306 via the 4G radio link 314 for both control signaling and user plane data transfer.

5G cellular wireless networks will offer higher data throughput speeds and lower latency data connections that will enhance existing services and applications while enabling new applications and services that take advantage of the improved performance 5G network. Increased performance will also entail higher power consumption and increased requirements for thermal dissipation management. Cellular wireless networks for an MNO 114 can include both 5G and 4G network components that allow a 5G UE 304 to access wireless services i) via a 5G SA connection (e.g., using a 5G radio link 316 as shown in FIG. 3A), ii) via a 5G NSA connection (e.g., using a 5G radio link 316 in parallel with a 4G radio link 318 as shown in FIG. 3B), or iii) via a 4G LTE connection (e.g., using only a 4G radio link 318 and operating in a 4G LTE mode). In some cases, a 5G SA connection includes a bandwidth part (BWP) feature to manage a portion of a channel that a wireless device 102 is required to monitor and on which resources may be allocated to the wireless device 102 for communication with the wireless network. In some cases, a 5G gNB 308, such as a 5G SA femto-cell, may be not configured to implement the BWP feature, and therefore the wireless device 102 can be required to monitor an entire bandwidth of a channel via which the wireless device 102 is camped on the 5G SA femto-cell. The wireless device 102 can be configured to detect whether the 5G SA femto-cell implements the BWP feature and whether additional conditions are satisfied to allow the wireless device to conserve battery power by enabling a lower RF band preferred mode to more and/or keep the wireless device 102 on a narrower bandwidth channel in a lower RF band rather than on a wider bandwidth channel in a higher RF band.

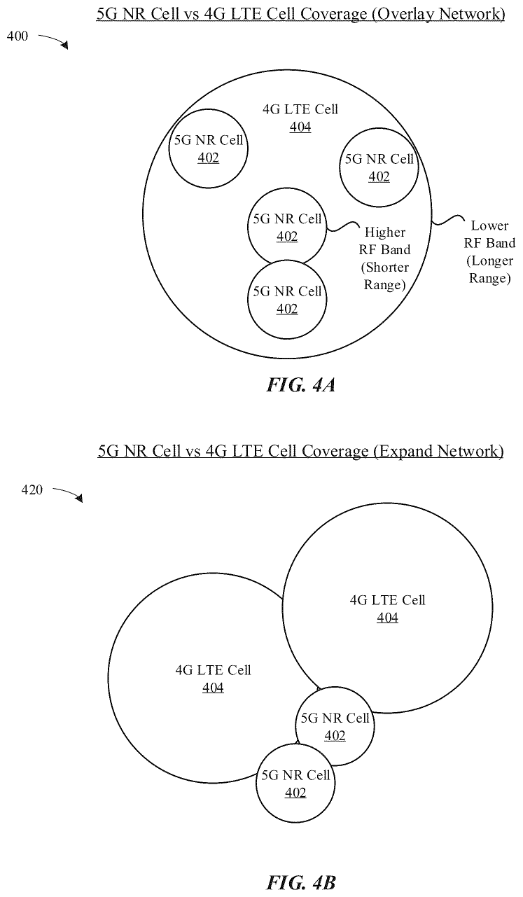

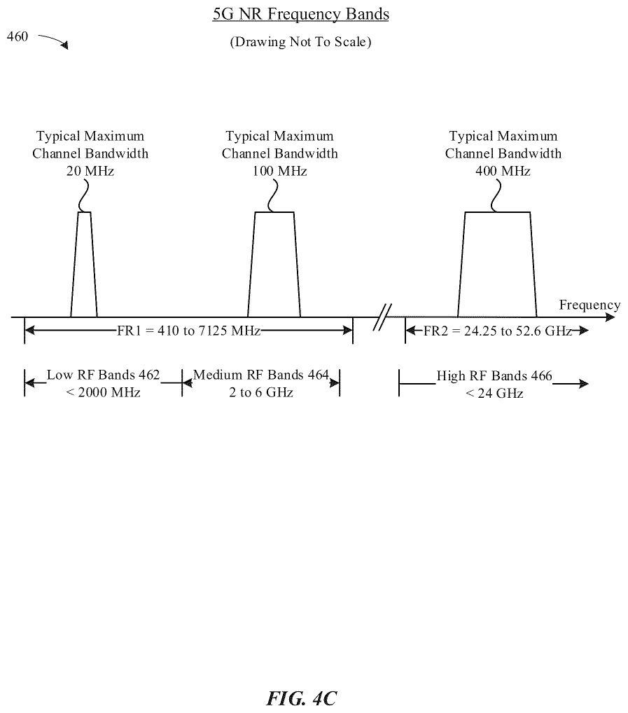

FIG. 4A illustrates a diagram 400 of an exemplary cellular wireless network in which multiple 5G new radio (NR) cells 402 are overlaid on a 4G LTE cell 404. The 5G NR cells 402 can use a radio frequency (RF) band that is higher in frequency than that of the 4G LTE cell 404 and can extend over a shorter range (distance) than the 4G LTE cell 404, which uses a lower RF band that has a higher coverage area. The 5G NR cells 402 can be installed at various times and complete overlapping coverage of 5G NR cells 402 with the 4G LTE cell 404 can be not achieved or require substantial investment and deployment over a period of time. At various geolocations, a 5G NR cell 402 may be not available to a wireless device 102. In addition, at some geolocations, a wireless device 102 may be operating at a far-range (peripheral edge) of a 5G NR cell 402 but within a mid-range to near-range of a 4G LTE cell 404 that the 5G NR cell 402 overlaps. Performance using a 4G LTE connection along to the 4G LTE cell 404 (in a 4G LTE mode) or using a 5G NSA connection with a 4G radio link in parallel with a 4G radio link may provide higher throughput (and/or other higher performance) than using a 5G SA connection with only a 5G radio link. In some embodiments, the wireless device 102 can use crowd-sourced network performance and network parameter information for a geolocation at which the wireless device 102 is operating (and in some cases knowledge of network deployment configuration) to determine whether to allow/disallow 5G SA connections via a higher RF band or prefer 5G SA connections (or 5G NSA connections or 4G LTE connections) in a lower RF band.

FIG. 4B illustrates a diagram 420 of another exemplary cellular wireless network in which multiple 5G NR cells 402 are partially overlaid with (or deployed in separate geographic areas from) 4G LTE cells 404, where the 5G NR cells 402 provide for network geographic coverage extension (as opposed to overlay in FIG. 4A). In this case, 5G SA connections can be preferred to 4G LTE connections when the wireless device 102 operates with a geographic area of the 5G NR cells 402, and a 5G NSA connection (which uses both 5G radio links and 4G LTE radio links) may not provide much additional performance, as the 4G LTE radio link would be at the far-range of the 4G LTE cell 404. The wireless device 102 can use knowledge of network deployment for particular MNO 114 to determine whether to enable/disable a 5G SA capability of the wireless device 102 in order to allow/disallow 5G SA connections via a higher RF band. In some cases, a 5G NR cell 402 can be a 5G NR SA femto-cell with a limited geographic range of operation.

FIG. 4C illustrates a diagram 460 of exemplary channels in different 5G NR frequency bands. The 5G wireless communication standards allow for operating in communication channels in various radio frequency (RF) bands. The RF bands can be grouped into i) RF bands that operate below 2 GHz, indicated as low RF bands 462, ii) RF bands that operates between 2 GHZ and 6 GHz, indicated as medium RF bands 464, and iii) RF bands that operate above 24 GHz, indicated as high RF bands 466. 5G NR frequency bands can also be grouped into those in a first frequency range (FR1) spanning 410 MHz to 7.125 GHz and those in a second frequency rage (FR2) spanning from 24.25 GHz to 52.6 GHz. Individual 5G RF bands are referred to using the letter n followed by a number, e.g., n1, n28, n78, etc. Within the individual 5G RF bands, one or more communication channels can be deployed by a base station 112, e.g., a 5G gNB 308 or access equipment of a 5G NR cell 402. A typical maximum bandwidth of a communication channel in a low RF band 462 spans 20 MHz. Similarly, a typical maximum bandwidth of a communication channel in a 4G LTE RF band spans 20 MHz. In a medium RF band 464, a typical maximum channel bandwidth spans 100 MHZ, thereby providing a substantially higher data throughput capability for a wireless device 102; however, receiving and transmitting via 100 MHz of bandwidth can increase power consumption by the wireless device 102. When in an idle state, e.g., camped on (associated with but not having an active data connection to) via a higher bandwidth (e.g., 100 MHZ) channel of a higher RF band, e.g., a medium RF band 464, can consume power of the wireless device 102 more rapidly than when idle on only a portion of the bandwidth of the higher bandwidth channel (e.g., when a BWP feature is deployed) or when idle on a narrower bandwidth channel (e.g., 20 MHZ) of a lower RF band, e.g., a low RF band 462. Moreover, the typical maximum bandwidth of a communication channel in a high RF band 466 spans 400 MHZ, thereby resulting in even higher power consumption by the wireless device 102 when the entire bandwidth of the communication channel must be monitored.

In some cases, a 5G NR SA femto-cell can be configured to use the BWP feature and allocate a narrower bandwidth of a channel to the wireless device 102. In some cases, a 5G NR SA femto-cell can be not configured to use the BWP feature (or not configure the wireless device 102 to use the BGWP feature) thereby requiring the wireless device 102 to monitor for control signals, e.g., for a physical downlink control channel (PDCCH), across the entire bandwidth of the wider bandwidth channel. In some cases, the wireless network can prefer connecting the wireless device via a 5G NR SA femto-cell rather than via a legacy 4G LTE cell. The wireless network can prioritize providing access to 5G NR SA service over conserving battery power of wireless devices 102 camped on the wireless network. In particular, 5G NR SA femto-cells have been deployed by MNOs 114 to expand 5G NR SA availability across enterprise environments, e.g., corporate campuses, event locations, e.g., sports stadiums, and public transportation hubs, e.g., metro stations. Without a BWP feature enabled, a wireless device 102 camped on a wider bandwidth channel of a higher RF band of a 5G NR SA femto-cell can consume power at a much higher rate than when camped on a narrower bandwidth channel of a lower RF band of the same 5G NR SA femto-cell or of a 4G LTE macro cell of the wireless network. This increased power consumption may have less impact on a wireless device 102 with a larger battery storage capacity, such as a cellular-enabled laptop computer; however, the increased power consumption can have a significant impact on a wireless device 102 with a smaller battery storage capacity, such as a mobile phone or a cellular capable wearable device. As described herein, a wireless device 102 can determine whether a 5G NR SA femto-cell is configured to use the BWP feature while camped on the 5G NR SA femto-cell via a wider bandwidth channel of a higher RF band, and when certain conditions are satisfied, the wireless device 102 can disassociate from the 5G NR SA femto-cell and re-associate with the same 5G NR SA femto-cell or with another cell of the wireless network in a narrower bandwidth channel of a lower RF band.

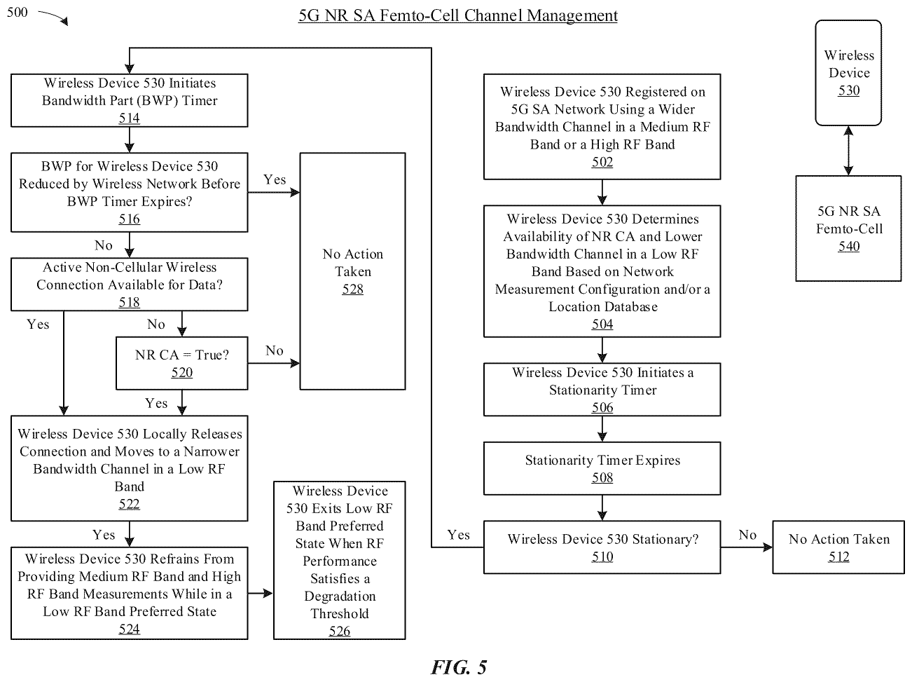

FIG. 5 illustrates a diagram 500 of an example of management of connections to a 5G NR SA femto-cell 540 by a wireless device 530. An exemplary embodiment of wireless device 530 can be wireless device 102 and/or one or more components of the wireless device 102 (e.g., processor(s) 104, baseband component 110, etc.). At 502, the wireless device 530 is registered on a 5G SA wireless network using a higher bandwidth channel in higher RF band, e.g., in a medium RF band 464 or in a high RF band 466. At 504, the wireless device 530 determines availability of 5G NR carrier aggregation (CA) and of a lower bandwidth channel in a low RF band 462 of the 5G SA wireless network. In some embodiments, the wireless device 530 determines availability of NR CA and/or the lower bandwidth channel in a low RF band 462 based on a network measurement configuration set by the 5G SA wireless network. In some embodiments, the wireless device 102 determines availability of NR CA and/or the lower bandwidth channel in the low RF band 462 based on a location database accessible to the wireless device 530, e.g., locally and or via remote access. In some cases, the location database includes information about cells of wireless network observed previously by the wireless device 530 and/or based on crowd-sourced information from other wireless devices 530. In some cases, availability of NR CA can confirm availability of a lower RF band, e.g., a low RF band 462 for use by a wireless device 530.

At 506, the wireless device 530 initiates a stationarity timer to determine a mobility state of the wireless device 530, e.g., whether the wireless device 530 is substantially stationary or moving (such that it would likely change cells). When camped on a 5G NR SA femto-cell 540 that has a substantially limited geographic range for a pre-determined period of time, the wireless device 530 can be considered to be in a stationary mobility state. In some cases, the wireless device 530 can use geolocation information, e.g., global positioning system (GPS) information or comparable information, to determine the mobility state of the wireless device 530. In some embodiments, the wireless device 530 uses information in a location database to determine properties of the 5G NR SA femto-cell 540 with which the wireless device 530 is associated. In some embodiments, the wireless device 530 uses information broadcast by the 5G NR SA femto-cell 540, e.g., a physical cell identifier (ID) value, to assist with determination of the mobility state of the wireless device 530. In some embodiments, the wireless device 530 correlates and/or confirms geolocation information from GPS information with geolocation information from a location database to determine the mobility state of the wireless device 530. In some cases, while the stationarity timer is running, the wireless device 530 can monitor for indications of whether the wireless device 530 is stationary or moving. In some cases, the wireless device 530 can wait until after expiration of the stationarity timer to determine whether the wireless device 530 is stationary or moving. At 508, the stationarity timer expires, and at 510, the wireless device 530 determines whether the wireless device 530 is stationary, e.g., remains associated with same 5G NR SA femto-cell 540 continuously for a pre-determined period of time associated with the stationarity timer. When the wireless device 530 is determined to not be stationary, at 510, the procedure can terminate with no action taken at 512, and the wireless device 530 can remain camped on the 5G NR SA femto-cell 540 via the higher bandwidth channel in the higher RF band, e.g., in a medium RF band 464, ranging from 2 to 6 MHZ, or in a high RF band above 24 GHZ.

After the wireless device 530 determines that it is in a stationary mobility state, the wireless device 530, at 514, initiates a bandwidth part (BWP) timer. While the BWP timer is running, the wireless device 530 can monitor for whether the 5G NR SA femto-cell 540 configures a BWP for the wireless device 530 to reduce the range of frequencies that the wireless device 530 must monitor. When the BWP is configured for the wireless device 530 by the 5G NR SA femto-cell 540, as determined at 516, the procedure can terminate with no action taken at 518, and the wireless device 530 can remain camped on the 5G NR SA femto-cell 540 via the higher bandwidth channel in the higher RF band, e.g., in a medium RF band 464, ranging from 2 to 6 MHz, or in a high RF band above 24 GHz. Notably, when the BWP is configured for the wireless device 530, the wireless device 530 can be required to monitor only a fraction of the entire bandwidth of the wider bandwidth channel, and therefore be able to conserve power while camped on the wider bandwidth channel in the higher RF band. When no BWP is configured for the wireless device 530 by the 5G NR SA femto-cell 540, as determined at 516, the wireless device 530 can determine, at 518, whether there is an active non-cellular wireless connection available for data transfer for the wireless device 530. When there is no active non-cellular wireless connection available for data transfer for the wireless device 530, as determined at 518, the wireless device 530 can determine, at 520, whether 5G NR CA is available for the wireless device 530. When 5G NR CA is not available for the wireless device 530, as determined at 520, and there is no active non-cellular wireless connection available for the wireless device 530, as determined at 518, the procedure can terminate with no action taken at 528, and the wireless device 530 can remain camped on the 5G NR SA femto-cell 540 via the higher bandwidth channel in the higher RF band, e.g., in a medium RF band 464, ranging from 2 to 6 MHz, or in a high RF band 466 above 24 GHz. When the BWP is not configured for the wireless device 530, as determined at 516, and i) an active non-cellular wireless connection, e.g., a Wi-Fi connection, is available for data transfer for the wireless device 530, or ii) 5G NR CA is available for the wireless device 530, as determined at 520, the wireless device 530, at 522, can locally release connection to the 5G NR SA femto-cell 540 and move to a lower bandwidth channel in a lower RF band, e.g., in the low RF band 462 below 2 GHz. The wireless device 102 can enable a low RF band preferred state and can locally release the connection by closing a radio resource control (RRC) connection to the 5G NR SA femto-cell 540. In some cases, the wireless device 530 provides a reason for terminating the RRC connection to the 5G NR SA femto-cell 540. The wireless device 530 can then camp on (re-associate with) the 5G NR SA femto-cell 540 or with another cell of the wireless network using a narrower bandwidth channel in a lower RF band. For example, the wireless device 530 can move from using a wider bandwidth (e.g., 100 MHz wide) channel in the 5G NR n78 band (in the 3.3 GHZ to 3.5 GHz frequency range) to a narrower bandwidth (e.g., 10 MHz wide) channel in the 5G NR n28 band (in the 703 to 803 MHz frequency range). At 524, the wireless device 530 can refrain from providing measurements for higher RF bands, e.g., for channels in the medium RF band 464 and for channels in the high RF band 466, while in a low RF band preferred state. By refraining from providing measurements for the higher RF bands, the wireless device 530 can forestall the wireless network from moving the wireless device 530 back to the 5G NR SA femto-cell 540 that does not have BWP configured. The wireless device 530 can monitor performance of the narrower bandwidth channel in the lower RF band and exit the low RF band preferred state when performance for the narrower bandwidth channel in the lower RF band does not satisfy a performance threshold, e.g., when performance degrades by a performance threshold amount (or more generally the performance of the narrower bandwidth channel in the lower RF band satisfies a performance degradation threshold). After exiting the low RF band preferred state, the wireless device 530 can provide measurements for one or more channels in the medium RF band or in the high RF band to allow the wireless network to move the wireless device 530 to a higher performing channel if available.

In some circumstances, the wireless network can perform a fallback procedure for the wireless device 530, e.g., move the wireless device 530 to a legacy RAT cell, from the narrower bandwidth channel in the lower RF band, in order to perform a voice connection, and after completion of the fallback procedure, the wireless network can move the wireless device 530 back to the wider bandwidth channel of the higher RF band of the 5G NR SA femto-cell 540 that does not have BWP configured. When the wireless device 530 detects re-association with the 5G NR SA femto-cell 540 via a wider bandwidth channel of a higher RF band after a fallback procedure completes, the wireless device 530 can substantially immediately release connection to the wider bandwidth channel of the higher RF band, enable the lower RF band preferred mode for the wireless device 530, and camp on the wireless network via a narrower bandwidth channel in a lower RF band without waiting for one or more timers.

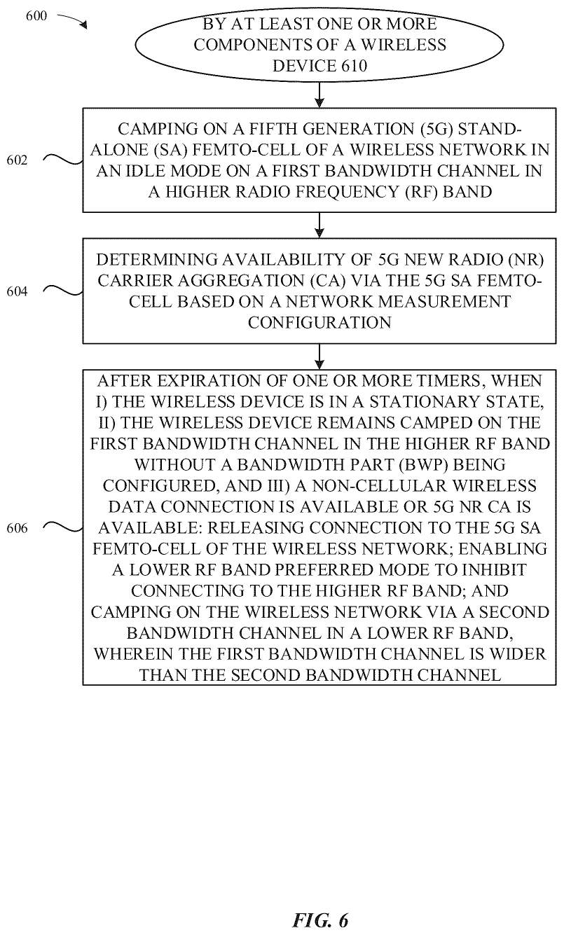

FIG. 6 illustrates a flowchart 600 of an exemplary method performed by at least one or more components of a wireless device 610 to manage connections to a 5G NR SA femto-cell. An exemplary embodiment of wireless device 610 can be wireless device 102 and/or one or more components of the wireless device 102 (e.g., processor(s) 104, baseband component 110, etc.). At 602, the wireless device 610 camps on a 5G SA femto-cell of a wireless network in an idle mode on a first bandwidth channel in a higher radio frequency (RF) band. At 604, the wireless device 610 determines availability of 5G new radio (NR) carrier aggregation (CA) via the 5G SA femto-cell based on a network measurement configuration. At 606, after expiration of one or more timers, when the following conditions are satisfied: i) the wireless device 610 is in a stationary state, ii) the wireless device 610 remains camped on the first bandwidth channel in the higher RF band without a bandwidth part (BWP) being configured, and iii) a non-cellular wireless data connection is available or 5G NR CA is available, the wireless device 610 can release connection to the 5G SA femto-cell of the wireless network, enable a lower RF band preferred mode to inhibit connecting to the higher RF band, and camp on the wireless network via a second bandwidth channel in a lower RF band, where the first bandwidth channel is wider than the second bandwidth channel.

In some embodiments, the method further includes determining availability of 5G NR CA via the 5G SA femto-cell based on an accessible location database of cell information. In some embodiments, the method further includes determining the wireless device 610 is in the stationary state based on continuous association with the 5G SA femto-cell for at least a pre-determined period of time. In some embodiments, the method further includes, after camping on the wireless network via the second bandwidth channel in the lower RF band and while performance of the second bandwidth channel in the lower RF band satisfies a performance threshold, refraining from providing measurements of the higher RF band to the wireless network. In some embodiments, the method further includes disabling the lower RF band preferred mode to allow camping on the higher RF band, when performance of the second bandwidth channel in the lower RF band does not satisfy a performance threshold. In some embodiments, the method further includes, after the wireless network moves the wireless device 610 to the higher RF band following performance of a fallback procedure before which the wireless device 610 was camped on a channel in a lower RF band, i) releasing connection to the higher RF band, ii) enabling the lower RF band preferred mode to inhibit connecting to the higher RF band, and iii) camping on the wireless network via a third bandwidth channel in the lower RF band, wherein the third bandwidth channel is narrower than the first bandwidth channel. In some embodiments, the second bandwidth channel in the lower RF band is on a 5G SA cell of the wireless network. In some embodiments, the second bandwidth channel in the lower RF band is on a fourth generation (4G) long term evolution (LTE) cell of the wireless network. In some embodiments, the second bandwidth channel spans a frequency bandwidth less than or equal to one-half a corresponding frequency bandwidth of the first bandwidth channel. In some embodiments, the second bandwidth channel spans a frequency bandwidth less than or equal to one-quarter a corresponding frequency bandwidth of the first bandwidth channel. In some embodiments, the lower RF band spans radio frequencies below 2 GHz, and the higher RF band spans radio frequencies above 2 GHz. In some embodiments, the lower RF band spans radio frequencies below 6 GHZ, and the higher RF band spans radio frequencies above 24 GHz. In some embodiments, the one or more timers include a stationarity timer to determine stationarity of the wireless device 102 for a pre-determined period of time. In some embodiments, the one or more timers include a bandwidth part timer to determine whether the wireless network configures the BWP for the wireless device 610.

### Representative Exemplary Apparatus

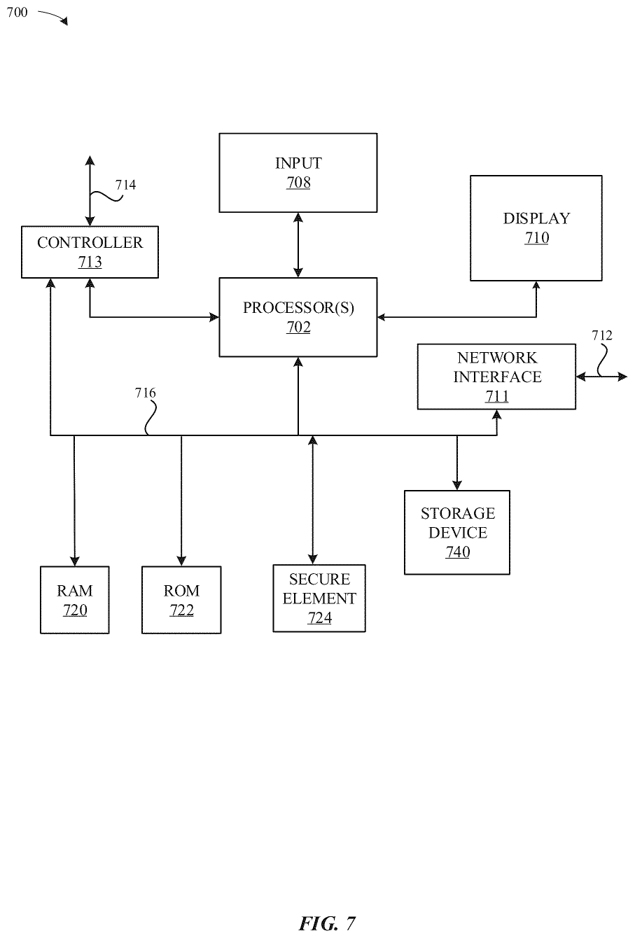

FIG. 7 illustrates in block diagram format an exemplary computing device 700 that can be used to implement the various components and techniques described herein, according to some embodiments. In particular, the detailed view of the exemplary computing device 700 illustrates various components that can be included in the wireless device 102. As shown in FIG. 7, the computing device 700 can include one or more processors 702 that represent microprocessors or controllers for controlling the overall operation of computing device 700. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband processor. The computing device 700 can also include a secure element 724. The secure element 724 can include an eUICC 108.

The computing device 700 also includes a storage device 740, which can include a single storage or a plurality of storages (e.g., hard drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for managing connection to a fifth generation (5G) stand-alone (SA) femto-cell, the method comprising:
by at least one or more components of a wireless device:
camping on a 5G SA femto-cell of a wireless network in an idle mode on a first bandwidth channel in a higher radio frequency (RF) band;
determining availability of 5G new radio (NR) carrier aggregation (CA) via the 5G SA femto-cell based on a network measurement configuration; and
after expiration of one or more timers, when i) the wireless device is in a stationary state, ii) the wireless device remains camped on the first bandwidth channel in the higher RF band without a bandwidth part (BWP) being configured, and iii) a non-cellular wireless data connection is available or 5G NR CA is available:
releasing connection to the 5G SA femto-cell of the wireless network;
enabling a lower RF band preferred mode to inhibit connecting to the higher RF band; and
camping on the wireless network via a second bandwidth channel in a lower RF band,
wherein the first bandwidth channel is wider than the second bandwidth channel.

2. The method of claim 1, further comprising:
determining availability of 5G NR CA via the 5G SA femto-cell based on an accessible location database of cell information.

3. The method of claim 1, further comprising:
determining the wireless device is in the stationary state based on continuous association with the 5G SA femto-cell for at least a pre-determined period of time.

4. The method of claim 1, further comprising:
after camping on the wireless network via the second bandwidth channel in the lower RF band and while performance of the second bandwidth channel in the lower RF band satisfies a performance threshold, refraining from providing measurements of the higher RF band to the wireless network.

5. The method of claim 1, further comprising:
disabling the lower RF band preferred mode to allow camping on the higher RF band, when performance of the second bandwidth channel in the lower RF band does not satisfy a performance threshold.

6. The method of claim 1, further comprising:
after the wireless network moves the wireless device to the higher RF band following performance of a fallback procedure before which the wireless device was camped on a channel in a lower RF band:
releasing connection to the higher RF band;
enabling the lower RF band preferred mode to inhibit connecting to the higher RF band; and
camping on the wireless network via a third bandwidth channel in the lower RF band,
wherein the first bandwidth channel is wider than the third bandwidth channel.

7. The method of claim 1, wherein the second bandwidth channel in the lower RF band is on a 5G SA cell of the wireless network.

8. The method of claim 1, wherein the second bandwidth channel in the lower RF band is on a fourth generation (4G) long term evolution (LTE) cell of the wireless network.

9. The method of claim 1, wherein the second bandwidth channel spans a frequency bandwidth less than or equal to one-half a corresponding frequency bandwidth of the first bandwidth channel.

10. The method of claim 1, wherein the second bandwidth channel spans a frequency bandwidth less than or equal to one-quarter a corresponding frequency bandwidth of the first bandwidth channel.

11. The method of claim 1, wherein:
the lower RF band spans radio frequencies below 2 GHz; and
the higher RF band spans radio frequencies above 2 GHz.

12. The method of claim 1, wherein:
the lower RF band spans radio frequencies below 6 GHz; and
the higher RF band spans radio frequencies above 24 GHz.

13. The method of claim 1, wherein the one or more timers include a stationarity timer to determine stationarity of the wireless device for a pre-determined period of time.

14. The method of claim 1, wherein the one or more timers include a bandwidth part timer to determine whether the wireless network configures the BWP for the wireless device.

15. An apparatus comprising memory coupled to processing circuitry, the processing circuitry configured to:
provide instructions to camp on a 5G SA femto-cell of a wireless network in an idle mode on a first bandwidth channel in a higher radio frequency (RF) band;
determine availability of 5G new radio (NR) carrier aggregation (CA) via the 5G SA femto-cell based on a network measurement configuration; and
after expiration of one or more timers, when i) a wireless device is in a stationary state, ii) the wireless device remains camped on the first bandwidth channel in the higher RF band without a bandwidth part (BWP) being configured, and iii) a non-cellular wireless data connection is available or 5G NR CA is available:
release connection to the 5G SA femto-cell of the wireless network; and
enable a lower RF band preferred mode to inhibit connecting to the higher RF band; and
provide instructions to camp on the wireless network via a second bandwidth channel in a lower RF band,
wherein the first bandwidth channel is wider than the second bandwidth channel.

16. The apparatus of claim 15, wherein the processing circuitry is further configured to:
determine availability of 5G NR CA via the 5G SA femto-cell based on an accessible location database of cell information.

17. The apparatus of claim 15, wherein the processing circuitry is further configured to:
after camping on the wireless network via the second bandwidth channel in the lower RF band and while performance of the second bandwidth channel in the lower RF band satisfies a performance threshold, refrain from providing measurements of the higher RF band to the wireless network.

18. The apparatus of claim 15, wherein the processing circuitry is further configured to:
disable the lower RF band preferred mode to allow camping on the higher RF band, when performance of the second bandwidth channel in the lower RF band does not satisfy a performance threshold.

19. The apparatus of claim 15, wherein the processing circuitry is further configured to, after the wireless network moves the wireless device to the higher RF band following performance of a fallback procedure:
provide instructions to release connection to the higher RF band;
enable the lower RF band preferred mode to inhibit connecting to the higher RF band; and
provide instructions to camp on the wireless network via a third bandwidth channel in a lower RF band,
wherein the first bandwidth channel is wider than the third bandwidth channel.

20. A wireless device comprising:
one or more antennas; and
one or more processors coupled to the one or more antennas and to a memory storing instructions that configure the one or more processors to:
camp, via at least one of the one or more antennas, on a 5G SA femto-cell of a wireless network in an idle mode on a first bandwidth channel in a higher radio frequency (RF) band;
determine availability of 5G new radio (NR) carrier aggregation (CA) via the 5G SA femto-cell based on a network measurement configuration; and
after expiration of one or more timers, when i) the wireless device is in a stationary state, ii) the wireless device remains camped on the first bandwidth channel in the higher RF band without a bandwidth part (BWP) being configured, and iii) a non-cellular wireless data connection is available or 5G NR CA is available:
release connection to the 5G SA femto-cell of the wireless network; and
enable a lower RF band preferred mode to inhibit connecting to the higher RF band; and
camp on the wireless network via a second bandwidth channel in a lower RF band,
wherein the first bandwidth channel is wider than the second bandwidth channel.
